(19) United States
(12) Patent Application Publication
(10) Pub. No.: US 2016/0147974 A1
(43) Pub. Date: May 26, 2016

(54) Distributable Computational Pathophysiology System Based on Organ Models

(71) Applicants: The Board of Trustees of the University of Illinois, Urbana, IL (US); Carle Health Care Incorporated d/b/a/ Carle Physician Group, Urbana, IL (US)

(72) Inventors: Lui R. Sha, Champaign, IL (US); Richard B. Berlin, JR., Champaign, IL (US)

(21) Appl. No.: 14/949,539

(22) Filed: Nov. 23, 2015

Related U.S. Application Data
(60) Provisional application No. 62/083,425, filed on Nov. 24, 2014.

(51) Int. Cl. G06F 19/00

(52) U.S. Cl. CPC G06F 19/3437; G06F 19/345; G06F 19/363

(57) ABSTRACT

An embodiment may involve repeatedly receiving input regarding health characteristics of a patient in a particular treatment environment. A treatment workflow for the patient may be determined and displayed. The treatment workflow may include one or more steps for diagnosing or treating the patient in the particular treatment environment. Determining the treatment workflow may involve, possibly based on the input, updating a state-based organ model that represents an organ state of the patient. Determining the treatment workflow may further involve, based on the updated state-based organ model and the particular treatment environment, selecting the treatment workflow for the patient from a plurality of treatment workflows.

### CROSS-REFERENCE TO RELATED APPLICATIONS

This application claims priority to U.S. Provisional Application No. 62/083,425, filed on Nov. 24, 2014, which is hereby incorporated by reference in its entirety herein.

### BACKGROUND

As medical devices become more elaborate and more is known about the details of various diseases, patient care has become increasingly complex, and involves a greater amount of data. This is particularly the case in acute care, where patients can be close to death and are therefore heavily monitored. Between human observations and machine-based measurements of vital signs, a critically ill patient can generate over 1000 individual data points per day. This number is expected to increase as use of genomics, inflammatory protein blood biomarkers, cellular markers and subtypes, radiologic information, and detailed medical record data becomes more prevalent in medicine.

Currently, medical information systems are compartmentalized and usually monitor and measure in isolation. For example, a heart rate monitor may trigger an alarm when a patient's heart rate exceeds or falls below certain thresholds. Similarly, a respiratory monitor may trigger a different alarm when the patient's breathing rate exceeds or falls below certain thresholds. These monitors and medical devices fail to consider the implications of multiple organ systems based on realistic models of disease and organ function. In newer integrated display systems, different physiological measures are displayed in a variety of locations, manners, or fashion. However, they still do not consider the interactions between organ states as disease evolves. As a consequence, these systems are not associated with workflows, monitoring, or treatment recommendations, and do not adapt or guide the physician regarding the patient's condition as a whole or the medical environment in which the patient is being treated.

### SUMMARY

The embodiments herein disclose a computational pathophysiological system that includes accurate, state-based models of organ and/or disease information and function. The system may include a pathophysiological model represented by interacting state machines of the organs, and a medical best practice recommendation engine that provides diagnosis and treatment workflows, if required or desired, as function of organ state, disease state, available medical equipment, and skill levels of attending medical staff. For example, the embodiments herein may use the International Guidelines for Management of Severe Sepsis and Septic Shock and/or the American Heart Association Guidelines for Cardiopulmonary Resuscitation and Emergency Cardiovascular Care. The organ state machines and best practice state machines make the guidelines executable in real-time or near real-time in the context of available medical equipment and medical expertise.

Particularly, the states of multiple interacting organ systems may be modeled so that disease progressions that impact more than one organ can be detected in an expeditious and accurate fashion. Based on the state of the detected disease (as reflected by the patient's organ states), the medical information system may recommend a treatment or recommend monitoring workflow. These workflows may recommend the performance of certain tests, administration of certain drugs, or the undertaking of other procedures, and may track the treatments and/or patient's response so that physicians have feedback in real-time. The workflows may be adapted to the patient's condition, treatment and/or environment. For instance, when one organ's function becomes subtly insufficient, it may affect other organs—this progress can be tracked by the embodiments herein.

Thus, for instance, the computational pathophysiological system may recommend treatments or monitoring for patients in the same general condition that are: (a) in an ambulance being transported by an emergency medical technician (EMT), (b) in a rural hospital with limited access to medical equipment and advanced technique or personnel, and (c) in an advanced regional hospital center being treated by an expert specialist physician. Moreover, in a network of hospitals and/or health care providers, a mobile component of the system follows the patient, for instance, from rural hospital, to ambulance transfer, to the regional hospital. Throughout this process, the system may be in communication with a server computing device at the regional hospital so that supervision by doctors at the regional hospital is available.

Accordingly, a first example embodiment may involve repeatedly receiving input regarding health characteristics of a patient in a particular treatment environment. A treatment workflow for the patient may be determined and displayed. The treatment workflow may include one or more steps (timed or otherwise) for diagnosing or treating the patient in the particular treatment environment. Determining the treatment workflow may involve, possibly based on the input, updating a state-based organ model that represents an organ state of the patient. Determining the treatment workflow may further involve, based on the updated state-based organ model and the particular treatment environment, selecting the treatment workflow for the patient from a plurality of treatment workflows.

In a second example embodiment, an article of manufacture may include a non-transitory computer-readable medium, having stored thereon program instructions that, upon execution by a computing device, cause the computing device to perform operations in accordance with the first example embodiment.

In a third example embodiment, a computing device may include at least one processor, as well as data storage and program instructions. The program instructions may be stored in the data storage, and upon execution by the at least one processor, cause the computing device to perform operations in accordance with the first example embodiment.

In a fourth example embodiment, a system may include various means for carrying out each of the operations of the first example embodiment.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a high-level depiction of a client-server computing system, according to an example embodiment.

FIG. 2 illustrates a schematic drawing of a computing device, according to an example embodiment.

FIG. 3 illustrates a schematic drawing of a networked server cluster, according to an example embodiment.

FIG. 4 is a block diagram depicting a computational pathophysiology system, according to an example embodiment.

FIG. 5 illustrates the relationships between a state-based model of a disease and state-based models of organ function, according to an example embodiment.

FIG. 6A illustrates a simplified state-based model of a respiratory system, according to an example embodiment.

FIG. 6B illustrates a simplified state-based model of a cardiovascular system, according to an example embodiment.

FIG. 6C illustrates a simplified state-based model of an immune system, according to an example embodiment.

FIG. 7 depicts how a computational pathophysiology system can be distributed and adapted to various treatment environments, according to an example embodiment.

FIG. 8A depicts a user interface, according to an example embodiment.

FIG. 8B depicts another user interface, according to an example embodiment.

FIG. 8C depicts yet another user interface, according to an example embodiment.

FIG. 8D depicts a system architecture, according to an example embodiment.

FIG. 9 depicts a high-level flow chart, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### 1. Overview

Physicians, nurses, and other medical professional are trained to understand health and disease in terms of organ systems and function—for instance, how organ function improves or deteriorates. Currently, nearly all understanding and related computation measures if needed, takes place within the brain of the medical professional. In an intensive care unit (ICU) as an example, physicians are overwhelmed with data inputs from the patient, medical devices that are monitoring the patient, lab reports, and other sources.

As an example, there are clearly written and widely disseminated guidelines for sepsis such as the Surviving Sepsis Campaign. These guidelines are in need of a device that functions in all medical environments and are able to guide a patient and medical professional through the urgent, time critical processes, techniques, and diagnostics to yield the lifesaving benefits. The system described herein is constructed to operate across platforms and environments to improve the time and safety critical elements of sepsis diagnosis, and to facilitate the providing of care and the documentation thereof.

As medical knowledge and data storage capabilities increase, more information will soon be available. For instance, the body can be thought of as a communication network of multiple cascades of secreted protein messengers. Before long, protein blood marker (immunoprotein) readings will be available at bedside. Additionally, genomics promises to provide even more patient data. The human mind cannot keep up with the data available today, much less the increased amount of data that is expected to be used for diagnosis and treatment in the future.

Aspects herein involve a computational pathophysiological system that can encode this data into models of organ operation, as well as models of diseases and medical best practices. Using these models, the system may recommend diagnoses and treatment workflows that are adapted to patient conditions and the particular treatment environment of the patient. The system can take in information from multiple sources, such as radiology information, recognized verbal speech, notes, text, medical histories, monitor outputs, lab results, etc. As a result, for example, an older man with crushing chest pain can be viewed differently from a young athlete even if both have a heart rate of 120 beats per minute. Thus, rather than merely having and array of isolated medical devices having individual alarms that signal when the values obtained on that device are beyond one or more thresholds, as well as isolated lab reports, the system uses codified pathophysiological models based on affected organ system states.

These pathophysiological models can be implemented in software, and the software can accept periodic, aperiodic, and/or continuous input data, such as a patient's vital signs, urine output, and neurological exam results for example. The software may also accept input based on lab reports of body fluid samples, levels of inflammatory biomarkers, a radiologist's finding from medical imaging, and so on. Using the computational pathophysiological system, organ function trend analysis and recognition of patterns in the form of correlated trends become possible in real-time.

The models and their default parameters may be based on best practice guidelines from governmental agencies and medical associations. On the other hand, default parameter values (such as thresholds) can be customized by attending physicians based on their own experiences and/or preferences. By bringing the advanced computational power to the bedside, the computational pathophysiological system greatly reduces a physician's workload, which in turn reduces medical errors caused by slips and lapses.

The system also allows trend analysis that tracks organ function over time. By viewing graphs or other representations of such trends and/or computational or other interactions of such trends, a medical professional can determine whether the patient's condition is improving or deteriorating. This can be accomplished through graphing many variables, using the information and measures for a particular organ system. For instance, a rising heart rate may be viewed in combination with one or more of: changes in blood pressure, timing of and response to intravenous (IV) fluids, measures of cardiac output, analysis of arterial waveforms, inputs from patient (e.g., worsening chest pain), inputs from physicians (e.g., an electrocardiogram (EKG) that shows an acute heart attack), and inputs from radiology testing. Thus, a broad view of the cardiovascular system and organ state can be provided at any given time. Computer implemented data analytics allows the identification of trends that a human might not notice, such as a slowly decreasing heart rate that is in fact slowing at an ever increasing rate, or show correlated changes in trends that are difficult to quantify.

Furthermore, the system goes beyond advanced data integration, displays, and alerts. It also actively coordinates the actions of a patient's treatment teams at bedside or across a hospital or health care network. It checks for potential treatment contraindications periodically, aperiodically, continuously, or upon alerts from one or more medical devices or systems. The system also manages the changing hierarchy of interleaved workflows as organ systems change state (e.g., responding to acute stress). It also informs physicians and nurses what procedures and/or tests have been performed, the patient's responses, and the candidate next steps in the workflow for the given situation.

In this way, the computational pathophysiological system is analogous to a turn-by-turn global positioning system (GPS) navigation guidance system. Like GPS guidance, the system adjusts its recommendations according to changing input from medical devices and/or humans. Thus, as the patient's conditions change, the system provides updated best-practice recommendations. Beyond GPS-like navigation guidance, the system provides guidance to members of the medical team whose members play different roles, and provides guidance across teams in a hospital network

One aspect of the system's clinical value is in the rapid execution of patient-specific and/or environment-specific best practice that allows reaching clinical milestones significantly faster. For instance, the American Heart Association and American Stroke Association have both concluded that, in acute care, shortened time to reach clinical milestones successfully is the most important indicator of outcome. When the heart stops, or there is a heart attack or stroke, every minute counts. Delay may result in avoidable damage to vital organs and results in patient suffering, and increased medical costs. Even worse, the opportunity to save a patient's life may close if diagnosis and treatment are too slow.

The system's direct financial return to hospitals is reaching clinical milestones, faster and more accurately, resulting in fewer complications and shorter patient stays in an intensive care unit (ICU) or another unit. Such results are financially favorable by an increasing number of medical insurance companies.

In addition, under current healthcare laws and regulations, regional healthcare facilities (e.g. regional hospitals) assume the role as center of accountable care organizations. The vital role for regional facilities may be achieved through their ability to manage acute and serious illness from the moment a patient arrives at a distant facility, through communication and transport, past arrival and triage at that regional center. The interface of medical devices, with information, communications, and humans, should be present and active throughout the patient experience, not only upon arrival at the regional center.

Thus, the system described herein is adaptable to various remote treatment environments, such as small hospitals, triage centers, and ambulances. For instance, the system may recommend different treatment workflows for a patient in a regional hospital versus a patient with the same symptoms in an ambulance. Further, the system allows patients to be handed off from a small hospital, to an ambulance, to a regional hospital without significant interruptions to their care.

As an example, suppose that time TO is when the patient arrives at a remote treatment environment. The system may make it possible to have as much treatment happen to the patient soon after time TO as would have happened had the patient arrived at the regional hospital. That is, analysis and treatment should be as close to T0 even the patient is at a remote facility and miles from advanced labs and experts. This involves engineering, communications, analytics and display.

To that point, the system may feature a user interface. In some embodiments, the interface may include the following parts: a system parameter setting interface, a system configuration interface, a system runtime interface, and a system fault tolerance interface.

The system parameter setting interface may allow attending physicians to change organ and/or disease models' default settings. The settings may be based on the trends of physiological variables and correlations between these trends. The coefficients describe correlated changes in physiological variables, based on an organ system model, that codify the patterns used by physicians to understand the patient's condition. Specifically, the system interface may be designed to reduce mental workload by storing and making available on request: (a) diagnoses, procedures and/or tests that have been performed on the patient previously, the patient's responses to the procedures and/or tests, and further procedures and/or tests that should be performed on the patient in the future, (b) information assembled from different monitoring devices and lab reports, (c) recent treatments performed and the patient's responses, (d) the ability to perform calculations, e.g., drug dosages, and/or (e) the patient's health characteristics to focus on according to their respective urgencies.

The system configuration interface may allow clinical engineers, together with physicians, to configure the treatment workflows to fit a particular treatment environment's training and equipment profiles. In addition to primary treatment workflows, alternative workflows can be configured. In addition, priorities can be set to change the hierarchy of treatment workflows that interleave during acute medical emergencies such as cardiac arrest or stroke.

The system runtime user interface can be used by doctors, nurses, and other medical professionals to execute the chosen treatment workflow. For instance, the system may recommend a particular treatment workflow, and display this workflow. As the patient's condition changes, the recommended and/or displayed workflow may be updated accordingly.

The system fault tolerance interface facilitates continued system operation in the event of the failure of some of its components. For instance, during runtime, tablets could be dropped, leads can be accidentally disconnected, and computing devices or medical devices may fail. The fault tolerance interface may allow users to continue working safely while the system recovers to full functionality. To support this functionality, the system may be designed to U.S. Food and Drug Administration (FDA) Class II device certification requirements. The system may also provide active/standby facilities that automatically detect and recover from computer hardware and software failures.

Further, a mobile client device may periodically, or from time to time, back itself up or otherwise synchronize with a server device hosted at a regional hospital or elsewhere. Thus, loss or failure of any given mobile client device can be mitigated by obtaining a backup mobile client device and re-synchronizing with the server device.

Additionally, wireless communication, especially during ambulance transfer of a patient, may be interrupted. However, the system provides an interlock between the server device at the regional hospital and the mobile client device. The interlock ensures that treatments initiated by the regional hospital will be executed only after a corresponding communication-failure-safe measure is already prepared at the ambulance. For instance, if a patient is being treated in an ambulance, the system might recommend a less aggressive treatment until the attending medical professional in the ambulance is fully briefed regarding the carrying out of a more aggressive procedure, and what to do should the communication fail afterward. These are examples of the interleaving of workflows, guidance, and elements of the system's safety features.

Moreover, through wirelessly-connected mobile client devices, the system may support seamless handoff for the patient between treatment environments. For example, the mobile client device may follow the patient and configure itself the current treatment environment of the patient. Alternatively, as the patient transfers from one treatment environment to another, a new mobile client device may synchronize with the system (e.g., download patient information from a server computing device) so that treatment of the patient can continue where it left off. The data that facilitates this handoff between treatment environments may be internally transferred and captured by the server computing device at a regional hospital, for instance.

The advantages of the embodiments described herein are numerous. The system transforms pathophysiology of organs described statically in medical texts to dynamic disease and organ state machines that can capture and represent a patient's conditions in real time. Using organ-state-based treatment workflow recommendations, the system provides physicians with not just a recommendation, but also one or more established medical rationales for the recommendation. The system also provides feedback to physicians in the form of patient responses to recent and current treatments, and tracks compliance with and deviation from best practices for purpose of auditing and review.

The embodiments herein facilitate both patient monitoring and treatment. The term “treatment workflow” is used herein for convenience, but does not mean that any such “treatment” requires a prescription, a drug, or a surgical procedure. Instead, a “treatment workflow” is a system that monitors as well—that is, the system guides the medical professionals' care of the patient by requesting certain information, certain measurements, or that treatment of the patient is delayed for some period of time.

Regardless of how they may be implemented, the embodiments herein may make use of one or more computing and network devices. These computing devices may include, for example, client devices under the control of users, and server devices that directly or indirectly interact with the client devices. Such devices are described in the following section.

The embodiments herein may be described in terms of a “system.” Nonetheless, these embodiments may involve methods or computer-readable implementations of methods that can be carried out and/or performed by various devices, device components, systems, or subsystems. Many medical details that may be important to physicians, but not germane to the embodiments herein, are omitted.

### 2. Example Computing Devices and Environments

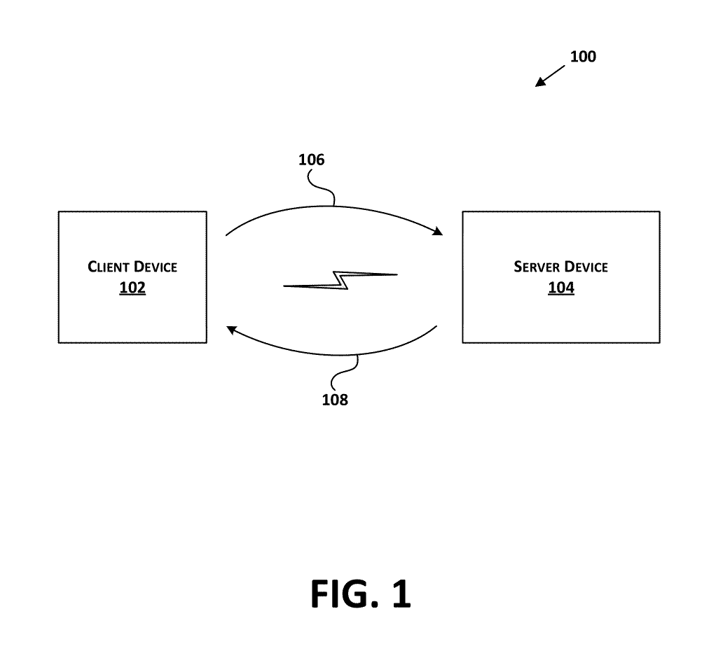

FIG. 1 illustrates an example communication system 100 for carrying out one or more of the embodiments described herein. Communication system 100 may include computing devices. Herein, a “computing device” may refer to either a client device, a server device (e.g., a stand-alone server computer or networked cluster of server equipment), or some other type of computational platform connected by a network.

Client device 102 may be any type of device including a personal computer, laptop computer, a wearable computing device, a wireless computing device, a head-mountable computing device, a mobile telephone, or tablet computing device, etc., that is configured to transmit data 106 to and/or receive data 108 from a server device 104 in accordance with the embodiments described herein. For example, in FIG. 1, client device 102 may communicate with server device 104 via one or more wireline or wireless interfaces. In some cases, client device 102 and server device 104 may communicate with one another via a local-area network. Alternatively, client device 102 and server device 104 may each reside within a different network, and may communicate via a wide-area network, such as the Internet.

Client device 102 may include a user interface, a communication interface, a main processor, and data storage (e.g., memory). The data storage may contain instructions executable by the main processor for carrying out one or more operations relating to the data sent to, or received from, server device 104. The user interface of client device 102 may include buttons, a touchscreen, a microphone, and/or any other elements for receiving inputs, as well as a speaker, one or more displays, and/or any other elements for communicating outputs.

Server device 104 may be any entity or computing device arranged to carry out the server operations described herein. Further, server device 104 may be configured to send data 108 to and/or receive data 106 from the client device 102.

Data 106 and data 108 may take various forms. For example, data 106 and 108 may represent packets transmitted by client device 102 or server device 104, respectively, as part of one or more communication sessions. Such a communication session may include packets transmitted on a signaling plane (e.g., session setup, management, and teardown messages), and/or packets transmitted on a media plane (e.g., text, graphics, audio, and/or video data).

Regardless of the exact architecture, the operations of client device 102, server device 104, as well as any other operation associated with the architecture of FIG. 1, can be carried out by one or more computing devices. These computing devices may be organized in a standalone fashion, in cloud-based (networked) computing environments, or in other arrangements.

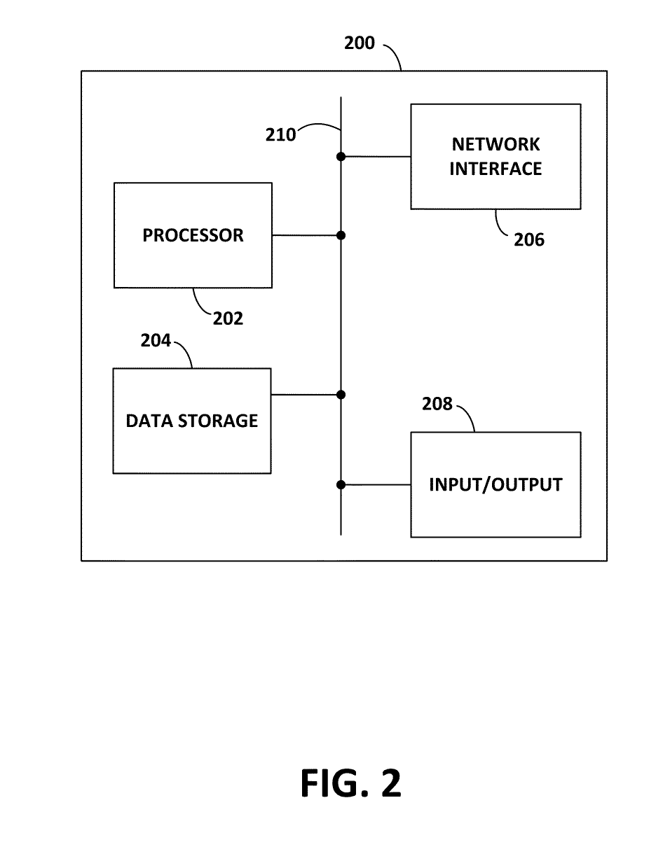

FIG. 2 is a simplified block diagram exemplifying a computing device 200, illustrating some of the functional components that could be included in a computing device arranged to operate in accordance with the embodiments herein. Example computing device 200 could be a client device, a server device, or some other type of computational platform. For purposes of simplicity, this specification may equate computing device 200 to a server from time to time. Nonetheless, the description of computing device 200 could apply to any component used for the purposes described herein.

In this example, computing device 200 includes a processor 202, a data storage 204, a network interface 206, and an input/output 208, all of which may be coupled by a system bus 210 or a similar mechanism. Processor 202 can include one or more CPUs, such as one or more general purpose processors and/or one or more dedicated processors (e.g., application specific integrated circuits (ASICs), digital signal processors (DSPs), network processors, etc.).

Data storage 204, in turn, may comprise volatile and/or non-volatile data storage and can be integrated in whole or in part with processor 202. Data storage 204 can hold program instructions, executable by processor 202, and data that may be manipulated by these instructions to carry out the various methods, processes, or operations described herein. Alternatively, these methods, processes, or operations can be defined by hardware, firmware, and/or any combination of hardware, firmware and software. By way of example, the data in data storage 204 may contain program instructions, perhaps stored on a non-transitory, computer-readable medium, executable by processor 202 to carry out any of the methods, processes, or operations disclosed in this specification or the accompanying drawings.

Network interface 206 may take the form of a wireline connection, such as an Ethernet, Token Ring, or T-carrier connection. Network interface 206 may also take the form of a wireless interface, such as IEEE 802.11 (Wifi), BLUETOOTH®, or a wide-area wireless interface, such as one used to access a cellular network or a satellite communication network. However, other forms of physical layer connections and other types of standard or proprietary communication protocols may be used over network interface 206. Furthermore, network interface 206 may comprise multiple physical interfaces.

Input/output 208 may facilitate user interaction with example computing device 200. Input/output 208 may comprise multiple types of input devices, such as a keyboard, a mouse, a touch screen, and so on. Similarly, input/output 208 may comprise multiple types of output devices, such as a screen, monitor, printer, or one or more light emitting diodes (LEDs). As an example, input/output 208 may display a recommended treatment workflow for a patient, as well as any relevant warnings or other information. Additionally or alternatively, example computing device 200 may support remote access from another device, via network interface 206 or via another interface (not shown), such as a universal serial bus (USB) or high-definition multimedia interface (HDMI) port.

In some embodiments, one or more computing devices may be deployed in a networked architecture. The exact physical location, connectivity, and configuration of the computing devices may be unknown and/or unimportant to client devices. Accordingly, the computing devices may be referred to as “cloud-based” devices that may be housed at various remote locations.

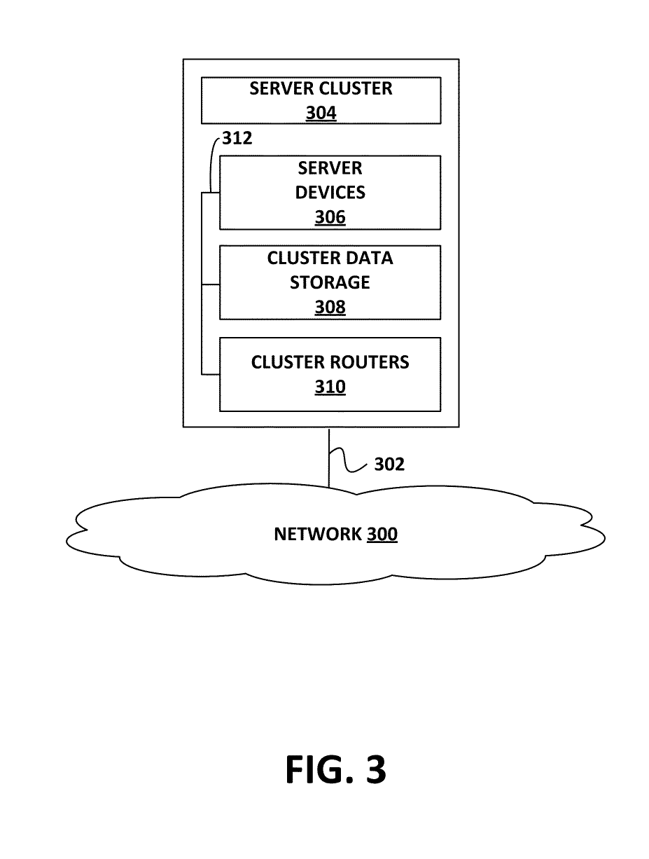

FIG. 3 depicts a cloud-based server cluster 304 in accordance with an example embodiment. In FIG. 3, functions of a server device, such as server device 104 (as exemplified by computing device 200) may be distributed between server devices 306, cluster data storage 308, and cluster routers 310, all of which may be connected by local cluster network 312. The number of server devices, cluster data storages, and cluster routers in server cluster 304 may depend on the computing task(s) and/or applications assigned to server cluster 304.

For example, server devices 306 can be configured to perform various computing tasks of computing device 200. Thus, computing tasks can be distributed among one or more of server devices 306. To the extent that these computing tasks can be performed in parallel, such a distribution of tasks may reduce the total time to complete these tasks and return a result. For purposes of simplicity, both server cluster 304 and individual server devices 306 may be referred to as “a server device.” This nomenclature should be understood to imply that one or more distinct server devices, data storage devices, and cluster routers may be involved in server device operations.

Cluster data storage 308 may be data storage arrays that include disk array controllers configured to manage read and write access to groups of hard disk drives. The disk array controllers, alone or in conjunction with server devices 306, may also be configured to manage backup or redundant copies of the data stored in cluster data storage 308 to protect against disk drive failures or other types of failures that prevent one or more of server devices 306 from accessing units of cluster data storage 308.

Cluster routers 310 may include networking equipment configured to provide internal and external communications for the server clusters. For example, cluster routers 310 may include one or more packet-switching and/or routing devices configured to provide (i) network communications between server devices 306 and cluster data storage 308 via cluster network 312, and/or (ii) network communications between the server cluster 304 and other devices via communication link 302 to network 300.

Additionally, the configuration of cluster routers 310 can be based at least in part on the data communication requirements of server devices 306 and cluster data storage 308, the latency and throughput of the local cluster networks 312, the latency, throughput, and cost of communication link 302, and/or other factors that may contribute to the cost, speed, fault-tolerance, resiliency, efficiency and/or other design goals of the system architecture.

As a possible example, cluster data storage 308 may include any form of database, such as a structured query language (SQL) database. Various types of data structures may store the information in such a database, including but not limited to tables, arrays, lists, trees, and tuples. Furthermore, any databases in cluster data storage 308 may be monolithic or distributed across multiple physical devices.

Server devices 306 may be configured to transmit data to and receive data from cluster data storage 308. This transmission and retrieval may take the form of SQL queries or other types of database queries, and the output of such queries, respectively. Additional text, images, video, and/or audio may be included as well. Furthermore, server devices 306 may organize the received data into web page representations. Such a representation may take the form of a markup language, such as the hypertext markup language (HTML), the extensible markup language (XML), or some other standardized or proprietary format. Moreover, server devices 306 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### 3. Example Computational Pathophysioloy System

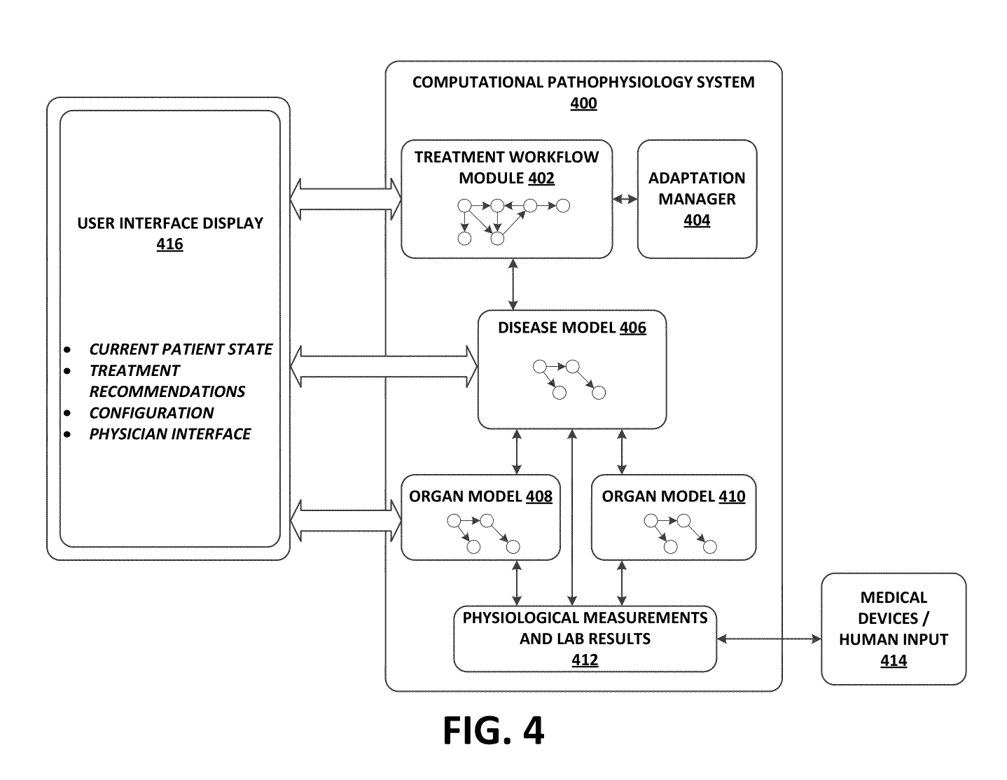

FIG. 4 is a block diagram depicting an example computational pathophysiology system 400. System 400 includes treatment workflow module 402, adaptation manager 404, disease model 406, and organ models 408 and 410. System 400 may be involved in the treatment of one or more patients. Thus, system 400 may receive physiological measurements and lab results 412 from one or more of medical devices/human input 414. Further, system 400 may support a user interface display 416.

In order to operate, system 400 may include one or more computing devices. In some embodiments, these computing devices may be exemplified by client device 102, server device 104, computing device 200, and/or server cluster 304. However, other combinations of hardware and/or software may be used.

Treatment workflow module 402 may include one or more workflows for specific diseases. A particular treatment workflow may, for instance, recommend one or more treatments for a patient based on disease model 406 and/or organ models 408 and 410. As an example, a recommended treatment might be performance of a test, administration of a drug, entry of monitored data, and so on.

The treatment workflows supported by system 400 may be canonical, in the sense that they may be approved by a reputable medical organization as a best practice. For instance, if disease model 406 and/or organ models 408 and 410 indicate that a patient is anaphylactic shock, treatment workflow module 402 may recommend administering epinephrine to the patient.

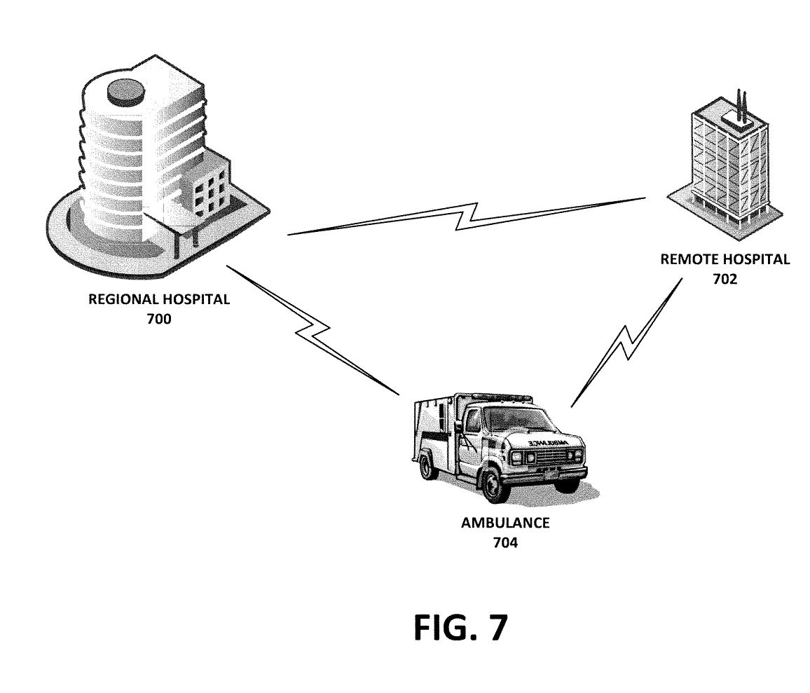

Adaptation manager 404 may be used to modify and/or select a particular treatment workflow based on a patient's treatment environment. For instance, a regional hospital may be able to provide a different treatment than a remote hospital or an ambulance. Thus, based on the medical equipment available in the patient's treatment environment and the level of expertise of the medical personnel in that treatment environment, adaptation manager may select a treatment workflow that is a feasible, recognized best practice for the patient. More detail on adaptation manager 404 can be found in the discussion of FIG. 7.

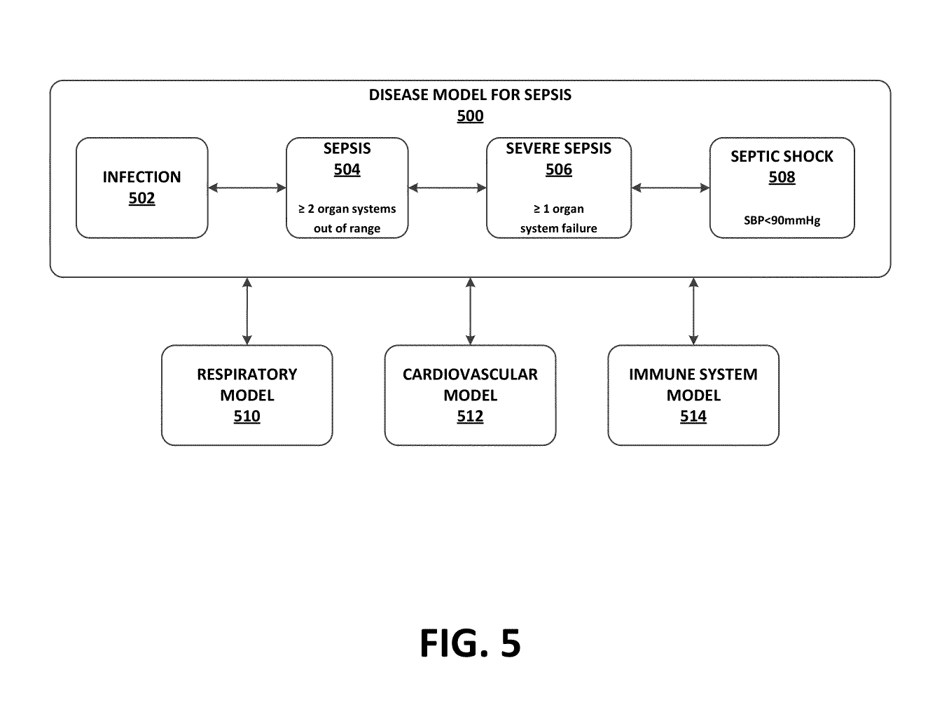

Disease model 406 may include one or more state-based models of particular diseases. For instance, a particular disease may be modeled as a finite-state automaton, with each state therein representing a respective state of the particular disease. Transitions between disease states are also represented in such automata. Disease model 406 may be used by treatment workflow module 402 to select a particular treatment. For instance, as the patient's disease changes state (e.g., becomes more or less severe), treatment workflow module 402 may modify its recommendations accordingly. An example disease model is described in more detail in the context of FIG. 5.

In some embodiments, treatment workflow module 402 may use disease model 406 in a predictive manner. For example, the current state of the patient's disease in disease model 406 may have a transition to a more serious state. Treatment workflow module 402 may recommend performance of a particular test, entry of data from a medical device, or more frequent patient monitoring so that, if the patient enters this more serious state, system 400 can rapidly detect the transition. Conversely, if the disease model transitions to a less serious state, the patient may be monitored less frequently.

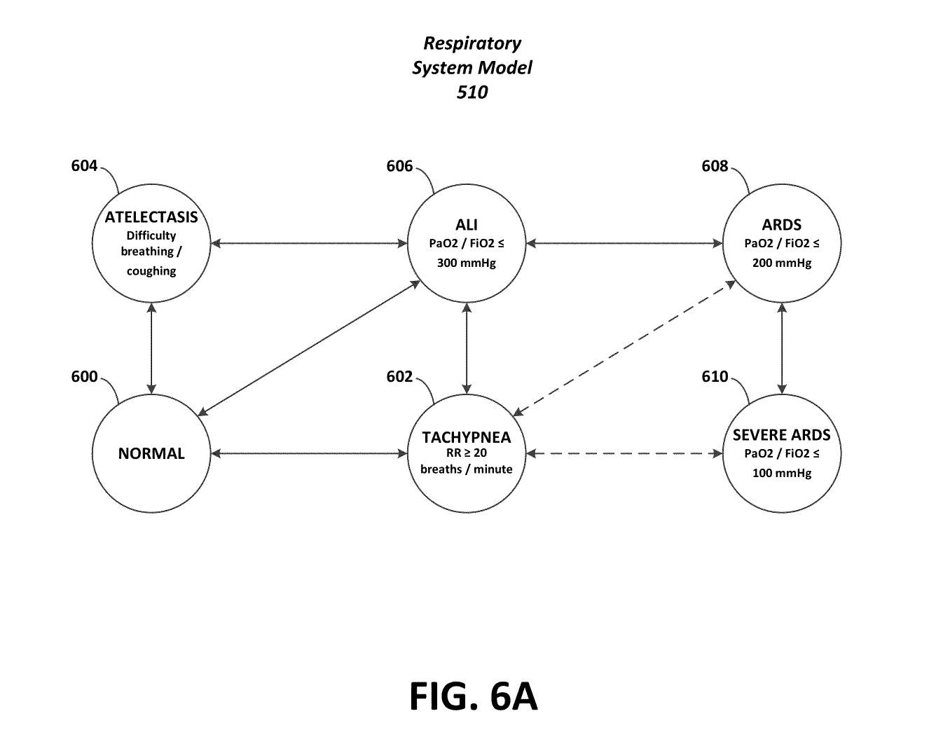

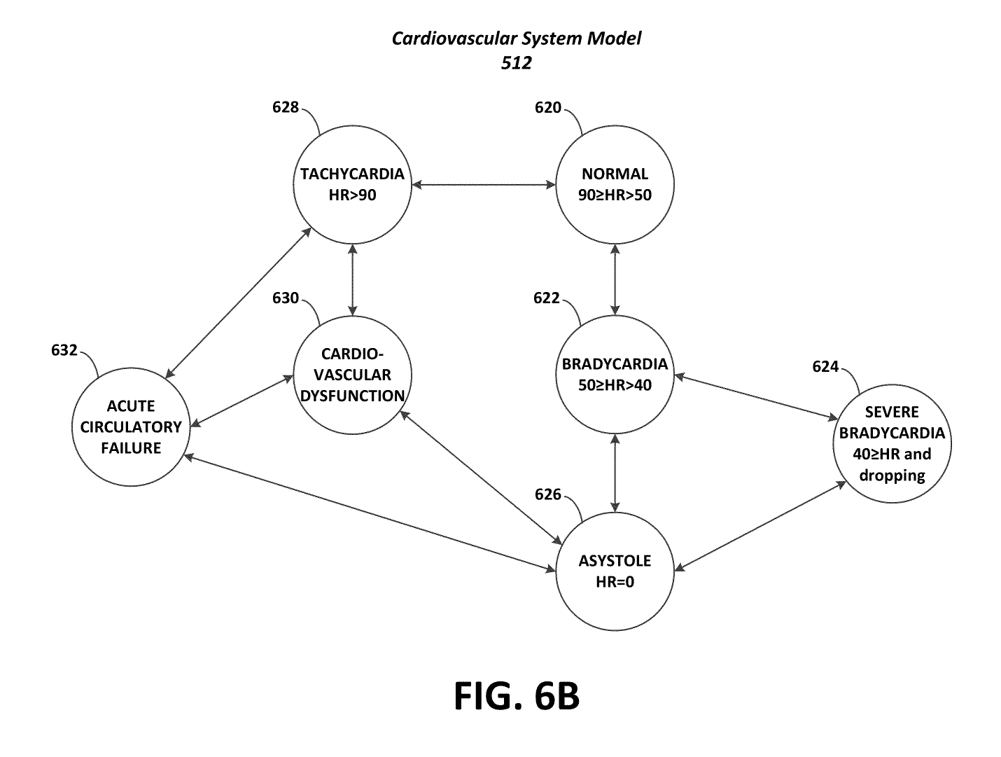

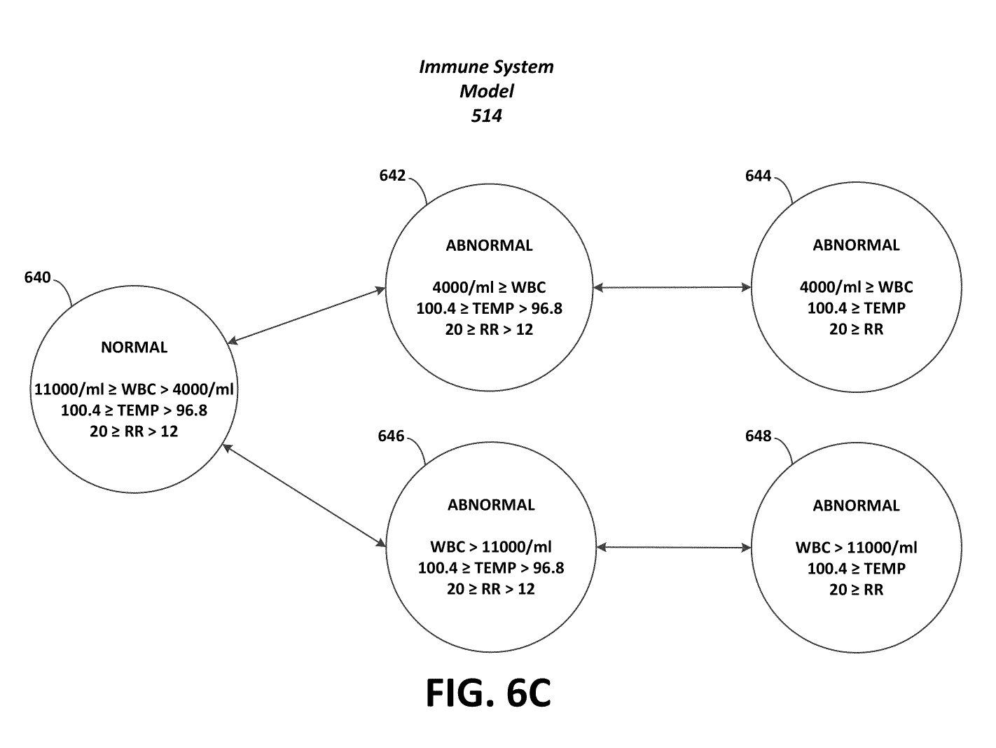

Organ models 408 and 410 each may include one or more state-based models of particular organs. For instance, a particular organ may be modeled as a finite-state automaton, with each state therein representing a respective state of the particular organ. Transitions between organ states are also represented in such automata. Although only two organ models are shown in FIG. 4, any number of organ models may exist. Example organ models are described in more detail in the context of FIGS. 6A-6C.

Organ models 408 and 410 may be used by disease model 406 to determine the state of the patient's disease(s). For instance, a particular disease state may be represented or indicated by one or more organs being in respective states. Further, one or more of organ models 408 and 410 may be used by treatment workflow module 402 to select a particular treatment.

Physiological measurements and lab results 414 may be provided to disease model 406 and/or organ models 408 and 410. Doing so may change the state of any of these finite-state automata. For instance, if the patient's heart rate is measured at less than 40 beats per minute, a cardiovascular organ state may change to a state of “severe bradycardia” and a disease state may also change accordingly.

Physiological measurements and lab results 414 may be provided by one or more medical devices and/or human input. For instance, medical devices (e.g., heart rate monitors, breathing monitors, etc.) may be coupled to system 400 so that the medical devices automatically report measurements and readings to system 400. Alternatively or additionally physiological measurements and lab results 414 may be manually entered by human users, such as doctors, nurses, and/or technicians.

In user interface display 416, system 400 may provide the current state of a patient, treatment recommendations for the patient, and possibly other patient information as well. User interface display 416 may include options through which system 416 as a whole may be configured, and/or a physician interface through which a physician can modify any of the models of system 400. In full generality, user interface display may support the system parameter setting interface, system configuration interface, system runtime interface, and system fault tolerance interface described above.

A mobile computing device may implements some or all of the features of system 400, either by running the appropriate software natively, or remotely with the assistance of a server computing device (e.g., by way of a web-based interface). This mobile computing device and/or server computing device may track the patient's conditions and treatments from a remote hospital, through ambulance transfer to a regional hospital. Data for handoff of the patient from the remote hospital to the ambulance and from the ambulance to the regional hospital may be automatically transferred with the patient and synchronized with the server computing device. This seamless handoff removes a major source of medical errors in current practice.

### 4. Example Disease Model

As an illustrative example of patient health modeling, FIG. 5 depicts the relationships between a state-based model of a disease and state-based models of organ function. FIG. 5 uses sepsis model 500 as an example model of the disease sepsis, and the respiratory, cardiovascular, thermoregulation, and immune systems as example organs. This model is simplified for the purpose of illustration. Many medial details that may be important to physicians, but not germane to the embodiments herein, are omitted. System 400, however, can be configured to model other diseases and other organs in greater detail for diagnosis and treatment. Examples of other organ systems include the lymphatic system, nervous system, endocrine system, integumentary system, muscular system, reproductive system, skeletal system, and gastrointestinal system.

Sepsis is a wide-spread inflammatory response to an infection. Diagnosis of sepsis in a patient with an infection is based on at least two of the following symptoms being present: abnormal body temperature, heart rate, respiratory rate or blood gas, or white blood cell count. Such organ function is considered abnormal when it is outside of a predefined normal range. Diagnosis of severe sepsis or septic shock is appropriate if the patient also exhibits hypotension, decreased urine output, or another indication of organ failure.

FIG. 5 models sepsis using four states. In more involved models, more states can be present. As discussed above, in order for a patient to be at risk for sepsis, the patient should have an infection. This is indicated by state 502 (infection). If an infected patient exhibits out of range organ functions for two or more of his or her respiratory, cardiovascular, or immune systems, the patient may transition to state 504 (sepsis). If a patient with sepsis exhibits at least one organ system failing, the patient may transition to state 506 (severe sepsis). If a patient with severe sepsis exhibits a systolic blood pressure (SBP) of 90 mmHg or less, the patient may transition to state 508 (septic shock).

On the other hand, a patient in state 508 (septic shock) can transition back to states 506 (severe sepsis) with an SBP of 90 mmHg or more. Likewise, a patient in state 506 (severe sepsis) can transition back to state 504 (sepsis) if no organ systems are failing, and a patient in state 504 (sepsis) can transition back to state 502 (infection) if less than two of his or her respiratory, cardiovascular, thermoregulation or immune systems are out of range.

The modeling of sepsis in FIG. 5 relies, in turn, on models of organ functions. Thus, respiratory model 510, cardiovascular model 512, and immune system model 514, provide input to sepsis model 500. In some embodiments, other organ models may be used. Respiratory model 510, cardiovascular model 512, and immune system model 514 may be considered to be examples of organ models 408 and 410.

One of the advantages of system 400 is rapid and cost-effective diagnosis of diseases like sepsis. Sepsis is a particularly important disease to diagnose and treat early. If sepsis is caught within the first hour of its development, the patient death rate is approximately 20%. This rate, however, increases 7% per each hour of delay. In a hospital where staff works 12-hour shifts, there may be an average 6 hour delay in detecting the onset of sepsis. Such a delay raises the death rate to approximately 62%. Since most patients with infection do not develop sepsis, most hospitals cannot afford to check every patient every hour.

System 400, on the other hand, can proactively monitor the health of a patient and recommend more frequent testing when the patient is at risk of developing sepsis. For instance, if one of the patient's organ systems is out of range, system 400 may recommend hourly monitoring of the patient. In this way, if a second of the patient's organ systems begins functioning out of range, the diagnosis of sepsis will occur no later than one hour after the disease develops, thus increasing the patient's chance of survival. Based on the age, existing chronic disease, patient organ condition, and/or the correlated trends of organ functions, data analytics may be performed to estimate the probability of transitioning to a more severe disease state. This provides a valuable early warning to the onset of serious adverse developments. An advantage of the system described herein is to bring the time-critical and safety features of guidelines such as those of the Surviving Sepsis Campaign to the bedside of all patients, no matter the location, the matter the environment, even if the patient is in a time consuming transport to a regional hospital center.

Despite the focus on sepsis, the model of FIG. 5 can be expanded to include other diseases, and their respective relationships to organ state.

### 5. Example Organ Models

FIG. 6A is an example embodiment of respiratory system model 510. The respiratory system regulates the intake and exchange of oxygen and carbon dioxide. Respiratory organs may include the lungs, trachea, bronchi, bronchioles, and diaphragm.

In state 600 (normal), the patient's respiratory organs are all within predefined “normal” ranges. From state 600 (normal), the patient may transition to state 602 (tachypnea). In this state, the patient's at-rest respiratory rate (RR) may be at least 20 breaths per minute (as measured by a medical device or a human). Tachypnea may be a sign that a systemic inflammatory response has spread to the respiratory system, for instance.

From state 600 (normal), the patient may also transition to state 604 (atelectasis). In this state, at least part of one or both of the patient's lungs may be collapsed. A patient with atelectasis may cough frequently and may have difficulty breathing.

From either state 600 (normal), state 602 (tachypnea), or state 604 (atelectasis), the patient may transition to state 606 (acute lung injury or ALI). In ALI, the patient's PaO2/FiO2 ratio is less than or equal to 300 mmHg. PaO2/FiO2 measures the ratio of arterial oxygen partial pressure to fractional inspired oxygen, which is a comparison between the oxygen level in the patient's blood and the oxygen concentration that the patient breathes. The value of this ratio may indicate a problem with how the patient's lungs transfer oxygen to the blood.

From state 606 (ALI), the patient may transition to state 608 (acute respiratory distress syndrome or ARDS). In ARDS, the patient's PaO2/FiO2 ratio is less than or equal to 200 mmHg. ARDS affects the alveoli of the lungs, and leads to decreased exchange of oxygen and carbon dioxide. ARDS may be caused a breakdown of the cells lining the lung's blood vessels, fluid accumulation in the lung, and/or excessive fibrous connective tissue formation.

From state 608 (ARDS), the patient may transition to state 610 (severe ARDS). In severe ARDS, the patient's PaO2/FiO2 ratio is less than or equal to 100 mmHg. Severe ARDS has similar, yet more extreme symptoms than ARDS, as well as a higher mortality rate.

Though less common, transitions may exist between state 602 (tachypnea) and state 608 (ARDS), as well as between state 602 (tachypnea) and state 610 (severe ARDS). These less common transitions are represented by dotted lines. In some embodiments, further states and transitions therebetween may be defined.

FIG. 6B is an example embodiment of cardiovascular system model 512. The cardiovascular system facilitates blood circulation and transportation of nutrients, oxygen, carbon dioxide, and hormones to and from the cells in the body. The cardiovascular system may include the heart, arteries, veins, and capillaries. Model 512 focuses on heart rate functions, namely bradycardia and tachycardia. Other model may focus on other cardiovascular aspects, such as irregular heart rhythms.

In state 620 (normal), the patient's heart rate may be at least 50 and no more than 90 beats per minute. From state 620 (normal), the patient may transition to state 622 (bradycardia), which is a heart rate of at least 40 and no more than 50 beats per minute. From state 622 (bradycardia), the patient may transition to state 624 (severe bradycardia), which is a heart rate of 40 beats per minute or less. From state 622 (bradycardia) or state 624 (severe bradycardia), the patient may transition to state 626 (asystole), where the patient's heart has stopped (e.g., the patient has flat-lined).

Also from state 620 (normal), the patient may transition to state 628 (tachycardia), which is a heart rate of over 90 beats per minute. From state 628 (tachycardia), the patient may transition to either state 630 (cardiovascular dysfunction) or state 632 (acute circulatory failure).

In state 630 (cardiovascular dysfunction), the patient may be suffering from a rhythm abnormality where the heart muscle itself is satisfactory, but the heart requires a rhythm correction in order to function properly. Alternatively, state 630 (cardiovascular dysfunction) may represent dehydration, where the blood volume in the cardiovascular system is low.

In state 632 (acute circulatory failure) the body is unable to provide tissues with enough blood for proper functioning. This may be caused by either abnormal cardiac function (e.g., insufficient cardiac output) and/or circularity failure (e.g., pooling of the blood due to vasodilation). Vasodilation, which may be a complication of infection or sepsis, and cardiac function depression, may lead to hypotension (low blood pressure). There may be times when such hypotension cannot be corrected by fluid therapy alone and additional complex and interactive medical treatments may be required.

From both of state 630 (cardiovascular dysfunction) and state 632 (acute circulatory failure), the patient may transition to state 626 (asystole). Further, although it is not shown in FIG. 6B, there may be a transition between state 628 (tachycardia) and state 626 (asystole).

FIG. 6C is an example embodiment of immune system model 514. The immune system protects a patient against disease. The states of immune system 514, however, are complex and can be measured or characterized by a combination of vital signs, including white blood cell (WBC) count, body temperature (temp), respiratory rate (RR) and immunoproteins (not shown).

As knowledge of the human immune system advances, more information may be included in immune system model 514. For instance, genomics—the study of gene expression in tissues, cells, and biologic systems—may eventually contribute to immune system model 514. Therefore, this model is rich, multidimensional, and expandable.

White blood cells (also referred to as leukocytes) are cells of the immune system that fight disease. A normal WBC count may be between 4,000/ml to 11,000/ml. A low WBC count may indicative of a depressed immune function, for example, and may place the patient at a greater than usual risk of infection. When a WBC is 11,000 or more, in the presence of immunologic system compromise, the patient may be having a hyper-inflammatory response, possibly as a response to infection.

Body temperature is the internal temperature of the patient's body. A normal body temperature may be between 96.8 degrees and 100.4 degrees Fahrenheit. A body temperature below this range may subject the patient to hypothermia, while a body temperature above this range may mean that the patient is suffering from a fever. In either case, the abnormal body temperature may be indicative of an underlying disease.

Respiratory rate is the breathing rate of the patient. A normal respiratory rate is between 12 and 20 breaths per minute. A low respiratory rate (hypopnea) may result in less oxygen entering the lungs, leading to low blood oxygen levels. As noted above, a high respiratory rate (tachypnea) may indicate that the patient has pneumonia, for example.

Immunoproteins are proteins in the patient's blood that may affect or play a role in the functioning of the immune system. Thus, immunoprotein levels may indicate presence of a disease or condition in the patient. There are many different immunoproteins, such as C-reactive protein and immunoglobulins, for instance.

Given the complexity of the immune system, an automaton representing the various permutations of values that each vital sign could possibly take on grows exponentially with the number of vital signs. For purpose of simplicity, FIG. 6C depicts a simplified model that ignores immunoproteins and consists of just a few of the possible states. In clinical practices and other embodiments of system 400, immune system model 514 may be more involved.

In state 640 (normal), the patient's WBC, body temperature, and respiratory rate are all within their respective normal ranges. In state 642 (abnormal), the patient's WBC is low, but other vital signs are still normal. This state might or might not be serious. For instance, some patients naturally have low WBC counts, while in others a low WBC count can be sign of cancer or an autoimmune disease that is affecting the patient's bone marrow. In state 644 (abnormal), the patient's WBC is low, and body temperature and respiratory rate are both high. This is a more severe state than state 642 (abnormal), and indicates that the patient should be diagnosed and treated rapidly.

In state 646 (abnormal), the patient's WBC is high, but other vital signs are still normal. A patient in this state typically is suffering from an infection, a reaction to a drug, and/or a disease of the bone marrow. In state 648 (abnormal), the patient's WBC is high, and body temperature and respiratory rate are both high. This is a more severe state than state 646 (abnormal), and indicates that the patient should be diagnosed and treated rapidly.

Clearly, immune system model 514 can have many more states of varying severities. System 400 may track the state of a patient's immune system state over time, and determine trends. If the patient is trending toward more severe states, system 400 may provide treatment recommendations, such as further tests and/or administration of drugs. However, if the patient's immune system is relatively stable, system 400 may recommend continued monitoring.

Today, immunological data is not organized and expressed as an “organ state.” This is a unique feature of the embodiments herein. Organizing immune system information as an organ allows the patient response to be organized in terms of the multidimensional organ state. This modeling is especially helpful for a disease like sepsis, which is a reflection of bodily defense mechanisms.

Further, the immune system “organ” is intimately connected to respiratory model 510 and cardiovascular model 512. These organ models receive feedback from one another, and may signal early organ failure, especially as a result of sepsis or infection. In sepsis, the progression from state 502 (infection) to state 508 (septic shock) reflects the intimate association of the immunology automata with those of other relevant organs, such as the heart, lung and kidney.

For each of the organ models in FIGS. 6A-6C, transitions may occur in any direction indicated by an arrow. Thus, for instance and with reference to FIG. 6C, a patient may transition from state 646 (abnormal) to state 640 (normal). Similar transitions from a less healthy state to a more healthy state may be made in the other organ models as well.

Additionally, the organ models of FIGS. 6A-6C may be parameterized. For instance, the threshold body temperatures of FIG. 6C may be changed to different values. This allows doctors, nurses, and/or other medical professionals to set the parameters (e.g., thresholds) of system 400 to preferred values. For example, system 400 may be configurable to specify that when a patient is in a certain combination of organ states, the patient should also be in a particular disease state. As a result, these medical professionals may be more likely to follow the recommendations of system 400, as it will more often agree with their own views of overall patient health.

### 6. Example Adaptation to Treatment Environments

As noted above, system 400 may adapt recommended treatment workflows to particular treatment environments. For purposes of example, FIG. 7 depicts how treatment can be adapted for patients in a regional hospital 700, a remote hospital 702, or an ambulance 704.

Regional hospital 700 may be an advanced hospital that serves a large geographic area. For instance, regional hospital may have specialists on staff from every major medical practice area, as well as up to date medical equipment and procedures. Regional hospital 700 may have access to almost any drug. Thus, a patient at regional hospital 700 may be able to be given a greater level of care than other treatment environments.

Remote hospital 702 may be a smaller hospital that is affiliated in some fashion with regional hospital 700. Remote hospital 702 may have general practitioners and some specialists on staff, but may lack expertise in certain other specialties. Further, remote hospital 702 might not have the most advanced medical equipment or procedures. Remote hospital 702 may have access to most, but not all, drugs. Thus, remote hospital 702 may be able to provide reasonable medical care to most patients, but patients with particular types of illnesses, or severe illnesses, might not be able to be treated properly at remote hospital 702.

Ambulance 704 is an automobile that transports patients from the site of an ambulance call to a hospital, or between hospitals. Ambulances are usually not staffed by doctors or nurses, and may or may not be staffed by an EMT. Also, ambulances typically have minimal medical equipment and drugs. Thus, treatment in ambulance 704 may be considered to be an intermediate treatment to stabilize a patient that will later be treated by a hospital.

System 400 can work in all of these treatment environments by adapting its recommended treatment workflows accordingly. System 400 may be hosted on server devices at regional hospital 700, or may be hosted by cloud-based server devices at another location (not shown). Regardless, client devices at regional hospital 700, remote hospital 702, and ambulance 704 may access system 400.

In some cases, the client devices may contain no specific client software for system 400—instead, they may access the server devices hosting system 400 by web-based interfaces, for example. In other cases, some or all of the software and data associated with system 400 may be present on the client devices.

Client devices associated with regional hospital 700, remote hospital 702, and ambulance 704 may be configured for those specific treatment environments. For example, a client device at regional hospital 700 may be configured with treatment and diagnostic options that rely upon advanced testing and medical knowledge. A client device at remote hospital 702, on the other hand, may be configured with only the treatment and diagnostic options available at remote hospital 702. Similarly, a client device at ambulance 704 may be configured with only the treatment and diagnostic options available in ambulance 704.

Further, the client devices and server devices of system 400 may be able to adapt to the possibility of unreliable communications between system 400 and the client devices. Suppose that system 400 is hosted at regional hospital 700. Remote hospital 702 might be connected by way of the Internet or a private network to regional hospital 700. Thus, communication between these hospitals should be generally reliable, but may be disrupted from time to time. Ambulance 704, however, will only be able to communicate with regional hospital 700 or remote hospital 702 over a wireless network (e.g., a cellular wide-area network using Long-Term Evolution (LTE) protocols). As a consequence, ambulance 704 might lose connectivity with regional hospital 700 more frequently, or may switch from a higher-speed wireless network to a lower-speed wireless network, as ambulance 704 moves in and out of wireless coverage areas with different data rates and reliability.

The treatment workflows recommended by system 400 may adapt to these specific treatment environments. In the case of ambulance 704, as an example, system 400 may take into account the equipment and the level of skill of the medical professional on the ambulance. Further, ambulance 704 may be equipped to report its GPS location to system 400, and system 400 may have access to mapping and navigation software that allows system 400 to track the progress of ambulance 400. Thus, system 400 may take into account the distance between the current location of ambulance 704 and its destination (e.g., regional hospital 700), as well as weather reports in the vicinity of ambulance 704, reports on road conditions, and so on. Based on some or all of this information, system 400 may periodically, aperiodically, or continuously estimate the amount of time until the patient arrives at regional hospital 700. Therefore, as the patient's conditions change, system 400 may recommend different treatment workflows.

With system 400, the patient should be no worse, under any circumstances, than they would be without it. Thus, suppose that a patient had a stroke and is rapidly en route by ambulance to regional hospital 700. Maintaining the patient's blood pressure within the strict guidelines for stroke can be crucial. A systolic blood pressure of 200 mmHg or above is to be avoided. But ambulances usually do not have the capability for tight blood pressure control, such as drugs that can keep systolic blood pressure in the range of 120-160.

Using system 400, ambulances can be equipped with these drugs even if the medical professional on the ambulance (e.g., an EMT) might not have the training or experience to use them on his or her own. By communicating, by way of a client device, with system 400 and/or a doctor at regional hospital 700 whose expertise is in the cardiovascular system, the medical professional on the ambulance can be guided through the administration of these drugs. System 400 and/or the doctor can also instruct the medical professional about possible side effects and reactions to watch for.

But if the communication with regional hospital 700 is impaired or unavailable, or if the drug administering device in the ambulance malfunctions, aspects of system 400 operating on the client device may recommend a treatment workflow that is a best practice for the treatment environment and skill level of the medical professional. This best practice may recommend no powerful IV drugs, monitoring the patient's blood pressure using an arm cuff when possible, sedating the patient, and driving rapidly.

Since system 400 may have access to an estimate of how long the patient will be en route to regional hospital, system 400 may recommend treatments accordingly. For instance, if the travel time is more than 30 minutes and the patient's condition is deteriorating, system 400 may recommend a more aggressive treatment than if the travel time is less or the patient's condition is more stable.

In some embodiments, system 400 may recommend treatments based on whether those treatments can be carried out safely without guidance from regional hospital 700. For instance, there may be two treatment options for a patient in ambulance 704, the first procedure more aggressive and risky than the second. The medical professional in the ambulance may be able to carry out the second procedure on his or her own, but might not be able to carry out the first procedure without assistance from regional hospital 700.

System 400 might recommend the first procedure if the medical professional can transition the patient safely from the first procedure to the second procedure in the case of communication loss with regional hospital 700. If such a transition cannot be made safely, system 400 might recommend the second procedure instead.

### 7. Example User Interfaces

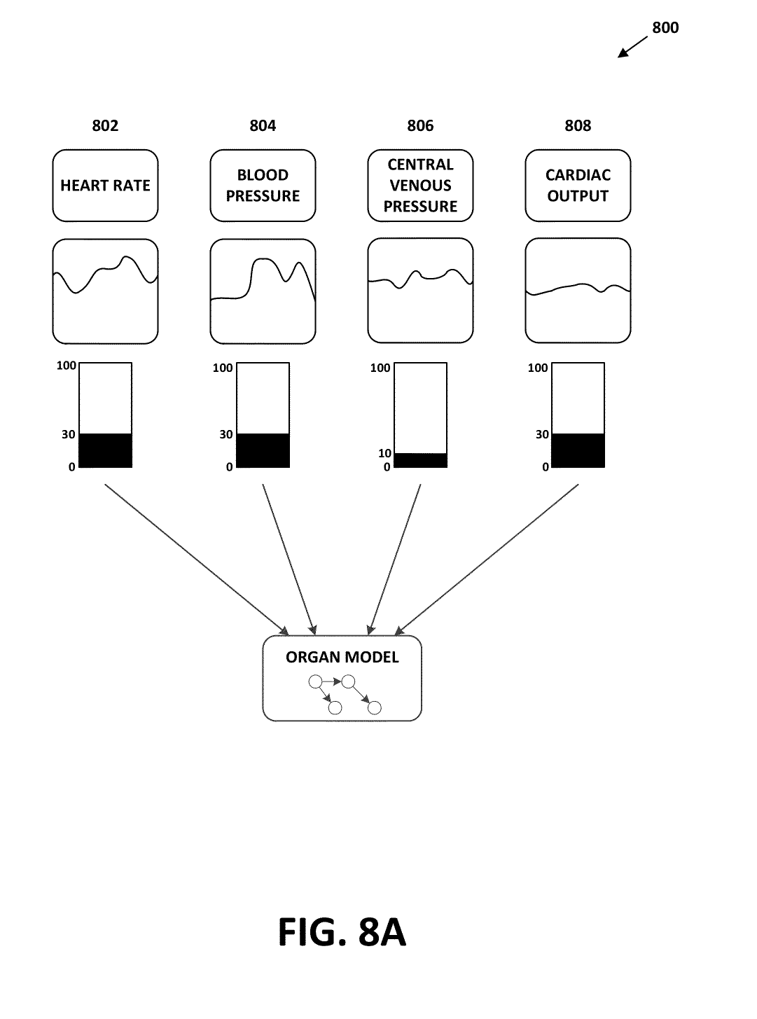

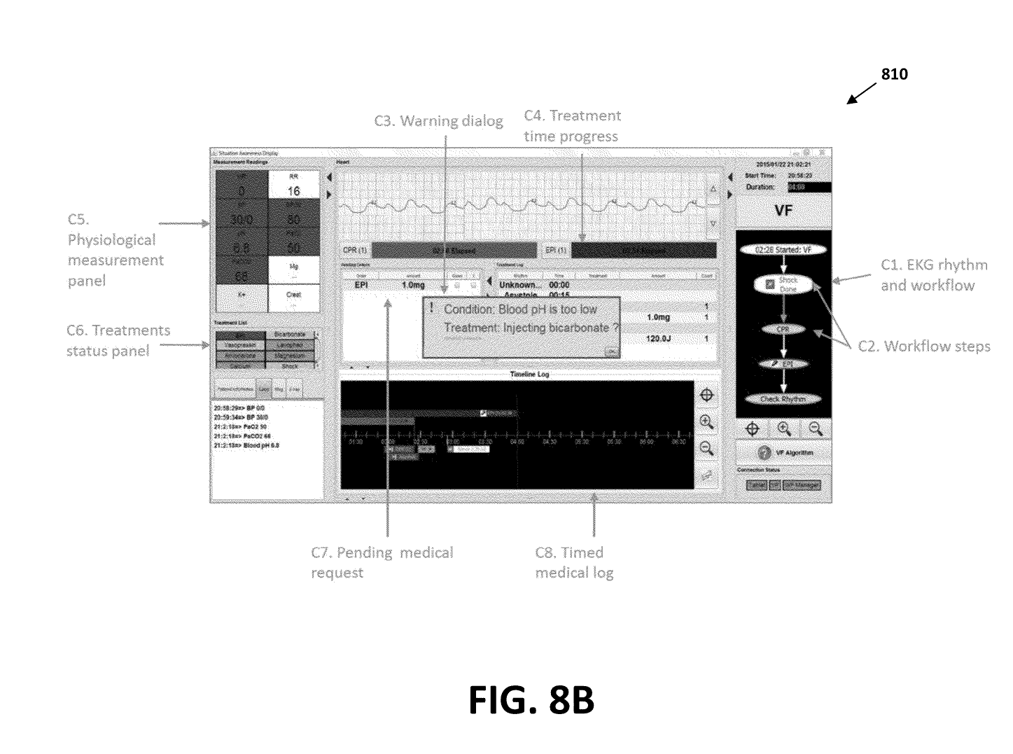

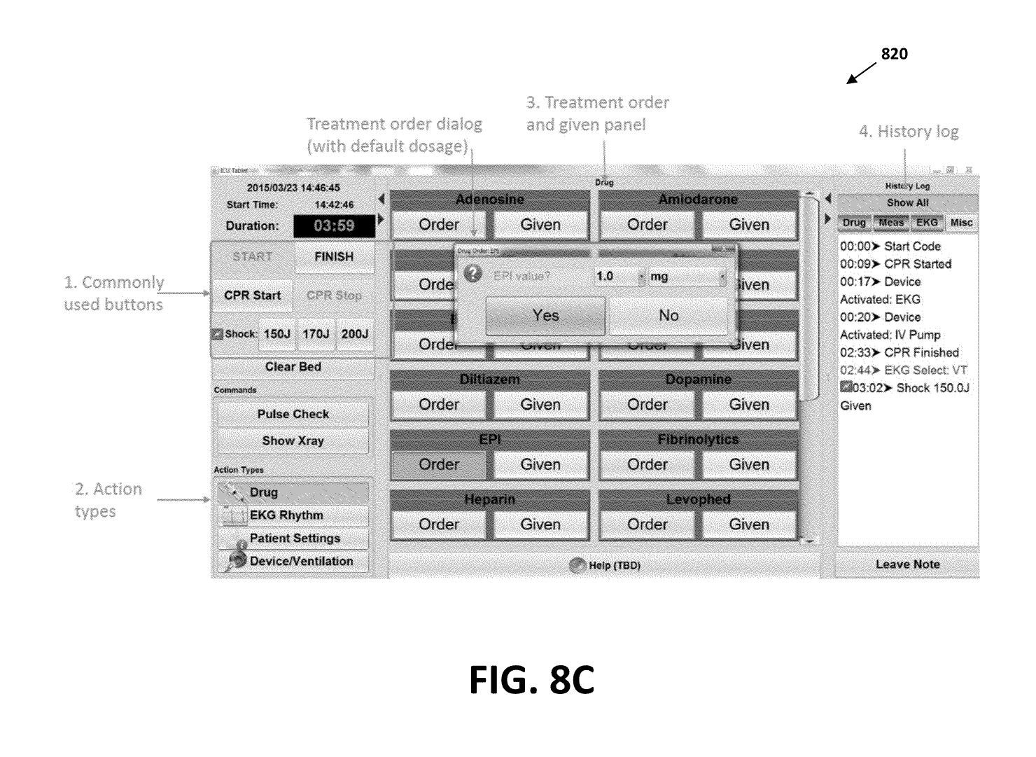

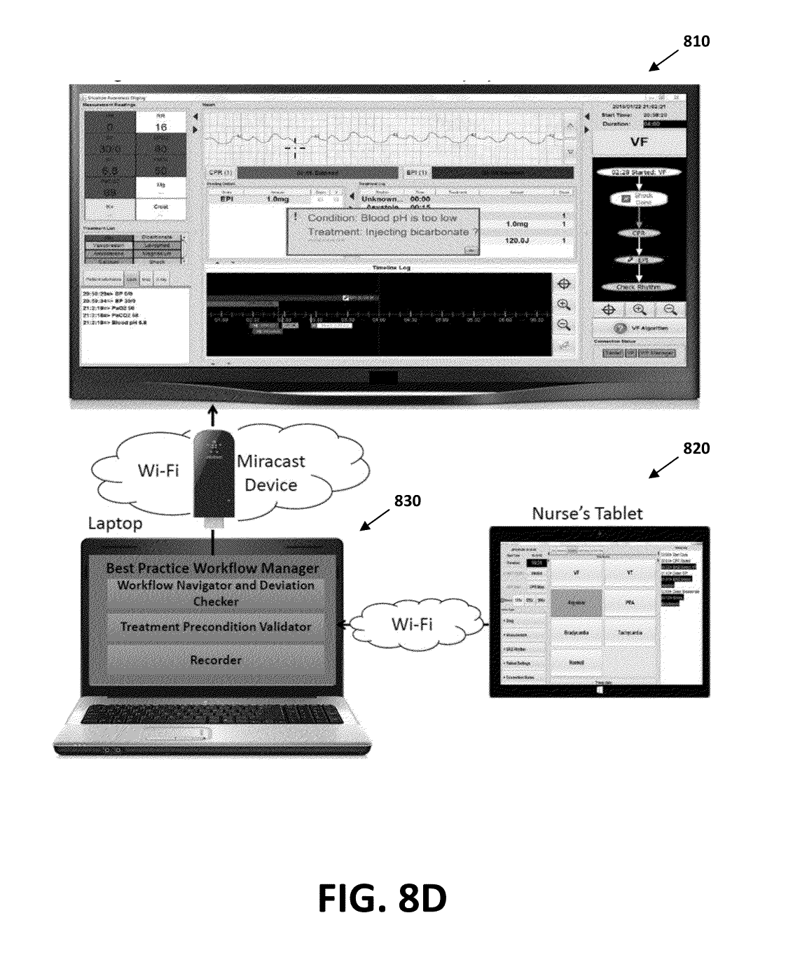

Based on the embodiments herein, a wide variety of user interfaces can be developed to display a patient's medical history, vital signs, organ state, disease state, and trends thereof. Two example user interfaces for system 400 are shown in FIGS. 8A and 8B. Other user interfaces are possible.

User interface 800 in FIG. 8A focuses on cardiovascular functions and is organized into four columns: heart rate 802, blood pressure 804, central venous pressure 806, and cardiac output 808. More or fewer columns may be present in user interface 800 based on the measurements and equipment available to system 400. Cardiac output may be measured as blood volume pumped per beat of the heart.

In each column a trend chart is shown, graphing measurements associated with the respective cardiovascular functions over time. In this way, a medical professional can determine trends in the patient's cardiovascular functions, some of which may indicate that the patient's condition is deteriorating or improving.

Also, below each trend chart, a slider is shown. A medical professional may adjust the slider to indicate the relative importance of each measurement. For example, in FIG. 8A, each of heart rate 802, blood pressure 804, and cardiac output 808 are given a weight of 30%, while central venous pressure 806 is given a weight of 10%. This indicates that the medical professional believes that heart rate 802, blood pressure 804, and cardiac output 808 are equally important indicators of the patient's health, but central venous pressure 806 is less so. These parameters may be customized, for instance, to indicate when an organ model or a disease model should change state.

As an example, these vital signs and their respective weights as shown in FIG. 8A may be taken into account in cardiovascular model 512. Given the weights, a heart rate, blood pressure or blood volume that is out of the predefined normal range may result in cardiovascular model 512 transitioning to an abnormal state faster than if central venous pressure is out of its predefined normal range. To illustrate this connection, each of heart rate 802, blood pressure 804, central venous pressure 806, and cardiac output 808 is shown as input to an organ model (e.g., cardiovascular system model 512). In some cases, one or more of these vital signs may be input to other organ models and/or disease models as well.

User interface 800, or variations thereof, may also be used as follows. In order to prevent a deadly transition from sepsis to septic shock, a key factor is to detect the potential onset of sepsis-induced hypotension early. A contributor to septic shock is vascular leakage and edema caused by inflammation of artery linings. The result is reduced blood volume in circulation. To compensate for reduced blood circulation, the cardiac system pumps faster and thus causes a faster heart rate. For early detection, a physician can determine if the circulating blood volume is in decline. A method to estimate the circulating blood volume is to rapidly introduce, perhaps intravenously, a sufficiently large amount of fluid and measure the real time responses in artery pressure and venous pressure. These numbers may be entered into a predetermined model of cardiac organ state function to include estimates of blood volume and cardiac output. Thus, models or organ state function, particularly of cardiac and respiratory organ, can be mapped and trended with immunology organ state to track a patient with sepsis who is deteriorating.

The system described herein provides a low cost and non-invasive early warning indicator. When a patient goes into septic shock, the blood pressure measured in the arm is no longer consistent with the internal blood pressure, since the body tries to preserve the blood circulation in the organs at the cost of the circulation in arms and legs. Thus, the combination of a decreasing trend of blood pressure measured in arm and in a central vein, a weakening correlation between blood pressure in the arm and in the central vein, and a rapidly increasing heart rate provides a warning that the patient's circulating blood volume may be decreasing and is in the process of crossing the acceptable threshold. Thus, the patient is likely moving toward septic shock. This early warning would alert physicians to take a closer look at the patient, as well as to take preventive measures as needed before septic shock is fully realized. User interface 800 may represent a simplified rendition of the current values and trending graphs of heart rate, blood pressure (on arm), central venous pressure, and blood volume. The current blood volume measurement, if available, as well as the estimated change of blood volume over time may be displayed in user interface 800. As a result, medical professionals can rapidly detect the onset of septic shock.

FIG. 8B is another example user interface 810. This user interface depicts how system 400 goes beyond merely the integration of patient vital signs, lab results, applicable treatments, and alerts by actively coordinating the actions of medical professionals according to a best practice workflow in the context of cardiac arrest resuscitation.

Display C1 illustrates a workflow for treating abnormal heart rhythm. The workflow is displayed in the context of cardiac arrest resuscitation based on patient conditions and a doctor's diagnosis input from a tablet (not shown).

Display C2 illustrates workflow steps. The status of a workflow step is categorized into “done”, “in progress”, and “should be performed”. Color coding is used to help discriminate between these categories. In the case shown, the patient has been defibrillated, so the Shock state is shown in white (done). The EPI (epinephrine) step has an outline in red. Red is used to draw doctors' and nurses' attention to the fact that it is time to administer epinephrine to the patient.

Display C3 is a warning dialog. If any potential deviation from the workflow is detected or any patient physiological measurement becomes abnormal, a warning dialog is shown to alert the medical team. The warning dialog may include an audible alert as well. In addition, if best practice guidelines suggest certain treatments for correcting the abnormal physiological measurement, the suggested treatments are also displayed. In the case shown, the team is being reminded that this patient's blood pH level is too low, and sodium bicarbonate is recommended.

Display C4 includes treatment time progress bars. These time progress bars may help the medical team meet the timing requirements of each action. At a glance, the team members can easily keep track of the temporal progress of the treatments.

Display C5 is a physiological measurements panel. System 400 may continuously monitor the patient's physiological measurements, e.g. heart rate and blood pressure, and the status of the measurements are color-coded. For instance, white means normal, red means seriously abnormal, and yellow means caution.

Display C6 is a treatment status panel. This panel shows the status of commonly used treatments, including epinephrine and sodium bicarbonate. The status of treatments is color-coded. Green means all the preconditions are satisfied. Yellow means some physiological measurements for validating the preconditions are missing; therefore, the medical staff should perform the treatment with caution. Red means contraindication is detected. Clicking on or otherwise activating this panel causes the detected contraindication to be displayed in a pop up window.

Display C7 is a pending medical requests table. When a doctor orders a treatment, the ordered treatment and dosage may be shown in the table until it is performed. If a treatment order is pending for longer than a nominal time interval, a warning dialog may be shown to remind the medical team of this fact.

Display C8 is a timed medical log. This log records all the diagnoses and treatments that have been performed, and displays them in a time sequence. Together with the recorded patient's physiological measurements, it allows doctors to assess the effectiveness of the current treatment approach.

FIG. 8C is yet another example user interface 820. This user interface may be used by a nurse, for instance, to input medical information. A drug panel order panel is used here as an example.

Display 1 includes commonly used buttons. There are some procedures or treatments, e.g. CPR and defibrillation, frequently performed during cardiac arrest resuscitation. In order to let the nurse quickly input that information, buttons pertaining to these procedures are grouped together.

Display 2 includes action types. The functionality of the nurse's tablet is categorized into four action types: drug, EKG rhythm, patient settings and device/ventilation settings. When the nurse selects any of these, a corresponding panel is displayed in the middle of user interface 820. The drug panel (shown) is used to input drug orders and dosages. The EKG rhythm panel (not shown) is used to input the rhythm diagnosis. Patient settings panel (not shown) is used to input the patient's personal information and medical history. Device/ventilation settings (not shown) are used to configure the thresholds of the physiological measurements.

Display 3 is the treatment order and given panel. This panel is used for entering drug orders and information about drugs that were given. First, a doctor in charge gives a drug order. Second, a nurse or other medical professional takes the drug from the drug drawer, checks the drug name and dosage, and administers it to the patient. Therefore, there are two buttons for each drug. When the nurse pushes the “Order” button of a drug, an order dialog is shown with guideline dosage as the default. When a drug is given to a patient, nurse pushes the “Given” button, and the system will record the time given and the dosage of the drug.

Display 4 is the history log. This log is for doctors and nurses to have a clear understanding of the established diagnosis and previously performed treatments.

FIG. 8D is an example system architecture. User interface 810 is display, e.g., by a computer at the patient's bedside. From laptop 830, a doctor, nurse, or other medical professional can access recommended and/or performed treatment workflows for the patient. A version of user interface 820 is shown on a nurse's tablet device. All of these devices may communication via Wifi, another wireless protocol, or by way of a wireline connection.

In FIG. 8D, cardiac arrest resuscitation guidance is used as an example application. First, the workflow manager displayed on laptop 830 checks if the actual treatment workflow follows the best practice workflow. If deviations are detected, alerts may be issued as a reminder. Second, the nurse uses the nurse's tablet to enter doctor's diagnosis. This diagnosis is used to select the best practice workflow. The nurse's tablet may also be used to enter the doctor's orders. Third, if a treatment is contraindicated for the patient current conditions, the treatment/drug button on display C6 turns red. If known precautions are found, the button turns yellow. Green button means neither contraindications nor precautionary warning are found. If medical staff clicks on the button, a popup window will show a list of checks performed and results of these checks. Fourth, all the diagnosis, treatment, alerts and warning in the entire process may be recorded for review.

System 400 may support similar user interfaces for other organ systems, such as the respiratory and immune systems. A user of system 400 may be able to switch between user interfaces like that of user interface 800 for each organ system.

### 8. Example Scenarios

To further appreciate the advantages of the embodiments herein, consider the following scenarios. The first two scenarios demonstrate how a patient in a hospital might be treated today, and the final scenario demonstrates how the embodiments herein can improve upon that treatment.

In the first scenario, without system 400, the patient is not equipped with a urine catheter, so urine output of the patient may be recorded based on asking the patient. However, this self-reporting on the part of the patient might not be reliable if the patient is forgetful, subject to delirium, or has dementia.

In the second scenario, also without system 400, the patient is equipped with a urine catheter that collects urine and is measured (emptied) every 8 hours. If there is no urine collected during an 8-hour period, a nurse may call the attending doctor, and the doctor may determine whether the patient's condition is serious. For example, the doctor may determine that the patient is suffering from renal failure. Alternatively, the doctor may order a blood urea nitrogen (BUN) test to determine the patient's kidney function. The doctor may also consider the state of the patient's heart, as certain heart conditions can trigger renal failure. The doctor may also consider the amount of IV fluid (if any) that has been going into the patient to determine whether the patient is retaining fluids.

In the third scenario, the patient is also equipped with a urine catheter, but is also monitored by system 400 as described herein. Urine output may be recorded every 15, 30, or 60 minutes according to the known patient kidney condition and the disease model. For example, sepsis induced acute kidney injury (AKI) is common in an ICU. Thus, confirmed sepsis indicates heightened monitoring of kidney function so that protective measure for the kidney can be performed before the onset of AKI. Should biomarkers be available, they can further facilitate the detection of the onset. Regardless, components in the urine may be measured if possible. Further, the current day's lab results for BUN are collected and compared with past trends. Also, the concentration of urine components may be measured, perhaps with a dipstick-type urine analysis. Any other information that is available, including past patient diagnoses (e.g., past kidney function) may be considered. If the patient's kidney function is known to be irregular or borderline irregular, the system may request more frequent urine measurements, and trend analysis of these measurements may be performed more often. The system may track or request the patient's medication list to see if patient is on a medication that relates to deteriorating kidney function.

In sum, all available information may be processed within the software as a kidney organ state. Thus, associations may be realized that humans would be unable to determine. Further, these associations may be tracked over time. Further, when urine protein biomarkers and genomics become available, they may be added to the computations. Thus, a doctor would have a view of kidney organ state and function, as well as predictions based on rates of variable changes within the organ model.

The results of measurements, tests, patient feedback, and trends thereof may be present for each organ on a user interface such as user interface 800. Consequently, in the third scenario, a patient's overall organ function is monitored more closely, and outlying vital signs can be detected rapidly and correlated with organ state. If the patient's health begins to deteriorate, the system may promptly detect the deterioration, and provide a theory of the patient's disease state, as well as recommendations of one or more courses of treatment.

Moreover, by considering overall patient characteristics and/or demographics, the system might recommend different treatments to patients with the same symptoms. For example, suppose that a 20-year-old athlete has abnormally low urine output for 8 hours. This patient has a heart rate of 50 beats per minute, but all other measured vital signs are in their respective normal ranges, and the patient can walk on his or her own. In this case, the system might determine that the patient is more likely dehydrated than suffering renal failure, and may recommend that the patient take in IV fluid while urine output is measured every four hours.

However, the recommended treatment for a 60-year-old patient with the same vital signs (e.g., no urine output for 8 hours, 50 beat per minute heart rate) who cannot walk on his or her own may be different. In this case, the system may recommend cardiovascular testing and monitoring the vital signs of the patient at an increased frequency.

### 9. Example Operations

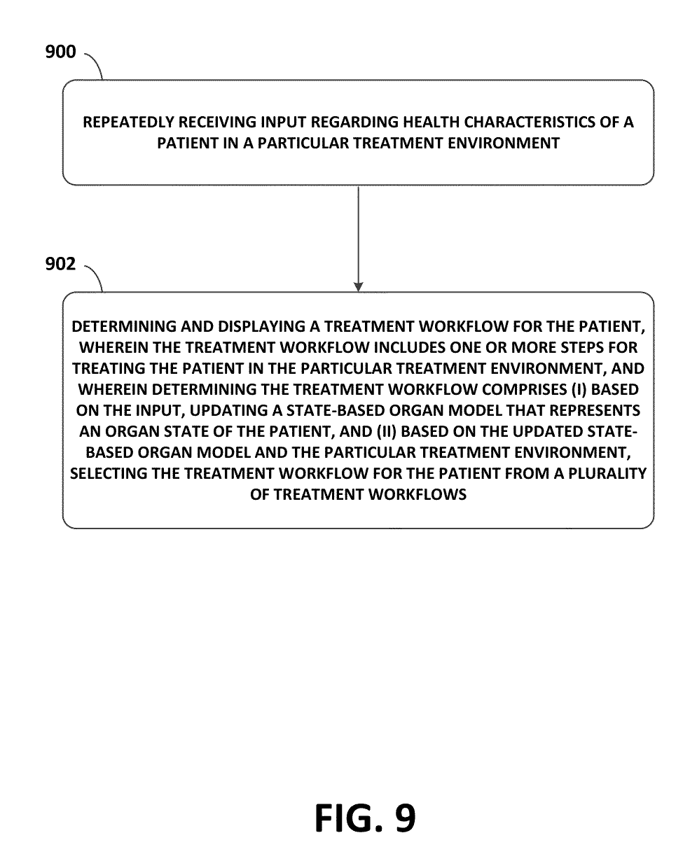

FIG. 9 is a flow chart illustrating a method according to an example embodiment. The process illustrated by FIG. 9 may be carried out by a computing device, such as computing device 200, and/or a cluster of computing devices, such as server cluster 304. However, the process can be carried out by other types of devices or device subsystems. For example, the process could be carried out by a portable computer, such as a laptop or a tablet device.

Block 900 may involve repeatedly receiving, by a computing device, input regarding health characteristics of a patient in a particular treatment environment. In some embodiments, the input may be provided by a user. Alternatively or additionally, the input may be provided by a medical device, where the input is based on a measurement performed by the medical device.

Block 902 may involve determining and displaying, by the computing device, a treatment workflow for the patient. The treatment workflow may include one or more steps for diagnosing or treating the patient in the particular treatment environment. Determining the treatment workflow may involve, possibly based on the input, updating a state-based organ model that represents an organ state of the patient. The state-based organ model may represent the patient's organ states and interactions therebetween.

Updating the state-based organ model may also be based on input from a medical professional. The state-based organ model may represent the states of at least two organ systems of the patient, where the states of the at least two organ systems, in combination, indicate the presence of a particular disease. The treatment workflow may be a medical best practice that recommends one or more treatments of the particular disease.

Determining the treatment workflow may further involve, possibly based on the updated state-based organ model and the particular treatment environment, selecting, by the computing device, the treatment workflow for the patient from a plurality of treatment workflows. The treatment workflow may recommend that at least one medical test be performed on the patient.

Determining the treatment workflow may also involve, further based on the input, updating a state-based disease model that represents a disease state of the patient. Selecting the treatment workflow for the patient from a plurality of treatment workflows may also be based on the updated state-based disease model.

In some cases, the particular treatment environment is a hospital environment, and the selected treatment workflow is adapted to the hospital environment. In other cases, the particular treatment environment is a remote environment in networked communication with a hospital environment that is providing treatment guidance to the remote environment. In the latter cases, selecting the treatment workflow for the patient from the plurality of treatment workflows may involve selecting the treatment workflow to be adapted to the remote environment.

For instance, the remote environment may be an ambulance environment, and selecting the treatment workflow for the patient from the plurality of treatment workflows may involve selecting the treatment workflow to be adapted to the ambulance environment. Alternatively, the remote environment may be a second hospital environment, and selecting the treatment workflow for the patient from the plurality of treatment workflows may involve selecting the treatment workflow to be adapted to the second hospital environment.

Further, in a remote environment, selecting the treatment workflow for the patient from the plurality of treatment workflows may involve determining that treatment of the patient at the remote environment can safely transition from a first procedure to a second procedure without the treatment guidance from the hospital environment, where the first procedure is more aggressive than the second procedure. Possibly in response to determining that treatment of the patient at the remote environment can safely transition from the first procedure to the second procedure without the treatment guidance from the hospital environment, the treatment workflow may be selected such that the first procedure is recommended over the second procedure.

Also, in such a remote environment, selecting the treatment workflow for the patient from the plurality of treatment workflows may involve determining that treatment of the patient at the remote environment cannot safely transition from a first procedure to a second procedure without the treatment guidance from the hospital environment, where the first procedure is more aggressive than the second procedure. Possibly in response to determining that treatment of the patient at the remote environment cannot safely transition from the first procedure to the second procedure without the treatment guidance from the hospital environment, the treatment workflow may be selected such that the second procedure is recommended over the first procedure.

In any event, selecting the treatment workflow to be adapted to the remote environment may involve selecting the treatment workflow based on medical equipment and personnel skill level available at the remote environment. Forms of adaptions may be agreed upon by physicians in advance. Alternatively or additionally, selecting the treatment workflow for the patient from the plurality of treatment workflows may involve selecting the treatment workflow based on estimated travel time between the remote environment and the hospital environment.

The embodiments of FIG. 9 may be simplified by the removal of any one or more of the features shown therein. Further, these embodiments may be combined with features, aspects, and/or implementations of any of the previous figures or otherwise described herein.

### 10. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrent or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method comprising:
repeatedly receiving, by a computing device, input regarding health characteristics of a patient in a particular treatment environment; and
determining and displaying, by the computing device, a treatment workflow for the patient, wherein the treatment workflow includes one or more steps for diagnosing or treating the patient in the particular treatment environment, and wherein determining the treatment workflow comprises (i) based on the input, updating a state-based organ model that represents an organ state of the patient, and (ii) based on the updated state-based organ model and the particular treatment environment, selecting, by the computing device, the treatment workflow for the patient from a plurality of treatment workflows.

2. The method of claim 1, wherein determining the treatment workflow also comprises:
based on the input, updating a state-based disease model that represents a disease state of the patient, and wherein selecting the treatment workflow for the patient from a plurality of treatment workflows is also based on the updated state-based disease model.

3. The method of claim 1, wherein the input is provided by a user.

4. The method of claim 1, wherein the input is provided by a medical device, and wherein the input is based on a measurement performed by the medical device.

5. The method of claim 1, wherein updating the state-based organ model that represents the organ state of the patient is also based on input from a medical professional.

6. The method of claim 1, wherein the particular treatment environment is a hospital environment, and wherein the selected treatment workflow is adapted to the hospital environment.

7. The method of claim 1, wherein the particular treatment environment is a remote environment in networked communication with a hospital environment that is providing treatment guidance to the remote environment, and wherein selecting the treatment workflow for the patient from the plurality of treatment workflows comprises selecting the treatment workflow to be adapted to the remote environment.

8. The method of claim 7, wherein the remote environment is an ambulance environment, and wherein selecting the treatment workflow for the patient from the plurality of treatment workflows comprises selecting the treatment workflow to be adapted to the ambulance environment.

9. The method of claim 7, wherein the remote environment is a second hospital environment, and wherein selecting the treatment workflow for the patient from the plurality of treatment workflows comprises selecting the treatment workflow to be adapted to the second hospital environment.

10. The method of claim 7, wherein selecting the treatment workflow for the patient from the plurality of treatment workflows comprises:
determining that treatment of the patient at the remote environment can safely transition from a first procedure to a second procedure without the treatment guidance from the hospital environment, wherein the first procedure is more aggressive than the second procedure; and
in response to determining that treatment of the patient at the remote environment can safely transition from the first procedure to the second procedure without the treatment guidance from the hospital environment, selecting the treatment workflow to recommend the first procedure over the second procedure.

11. The method of claim 7, wherein selecting the treatment workflow for the patient from the plurality of treatment workflows comprises:
determining that treatment of the patient at the remote environment cannot safely transition from a first procedure to a second procedure without the treatment guidance from the hospital environment, wherein the first procedure is more aggressive than the second procedure; and
in response to determining that treatment of the patient at the remote environment cannot safely transition from the first procedure to the second procedure without the treatment guidance from the hospital environment, selecting the treatment workflow to recommend the second procedure over the first procedure.

12. The method of claim 7, wherein selecting the treatment workflow to be adapted to the remote environment comprises selecting the treatment workflow based on medical equipment and personnel skill level available at the remote environment.

13. The method of claim 7, wherein selecting the treatment workflow for the patient from the plurality of treatment workflows comprises selecting the treatment workflow based on estimated travel time between the remote environment and the hospital environment.

14. The method of claim 1, wherein the treatment workflow recommends that at least one medical test be performed on the patient.

15. The method of claim 1, wherein the state-based organ model represents the states of at least two organ systems of the patient, wherein the states of the at least two organ systems, in combination, indicate the presence of a particular disease, and wherein the treatment workflow recommends treatment of the particular disease.

16. An article of manufacture including a non-transitory computer-readable medium, having stored thereon program instructions that, upon execution by a computing device, cause the computing device to perform operations comprising:
repeatedly receiving input regarding health characteristics of a patient in a particular treatment environment; and
determining and displaying a treatment workflow for the patient, wherein the treatment workflow includes one or more steps for diagnosing or treating the patient in the particular treatment environment, and wherein determining the treatment workflow comprises (i) based on the input, updating a state-based organ model that represents an organ state of the patient, and (ii) based on the updated state-based organ model and the particular treatment environment, selecting the treatment workflow for the patient from a plurality of treatment workflows.

17. The article of manufacture of claim 16, wherein determining the treatment workflow also comprises:
based on the input, updating a state-based disease model that represents a disease state of the patient, and wherein selecting the treatment workflow for the patient from a plurality of treatment workflows is also based on the updated state-based disease model.

18. The article of manufacture of claim 16, wherein the particular treatment environment is a hospital environment, and wherein the selected treatment workflow is adapted to the hospital environment.

19. The article of manufacture of claim 16, wherein the particular treatment environment is a remote environment in networked communication with a hospital environment that is providing treatment guidance to the remote environment, and wherein selecting the treatment workflow for the patient from the plurality of treatment workflows comprises selecting the treatment workflow to be adapted to the remote environment.

20. A computing device comprising:
at least one processor;
memory; and
program instructions, stored in the memory, that upon execution by the at least one processor cause the computing device to perform operations comprising:
repeatedly receiving input regarding health characteristics of a patient in a particular treatment environment; and
determining and displaying a treatment workflow for the patient, wherein the treatment workflow includes one or more steps for diagnosing or treating the patient in the particular treatment environment, and wherein determining the treatment workflow comprises (i) based on the input, updating a state-based organ model that represents an organ state of the patient, and (ii) based on the updated state-based organ model and the particular treatment environment, selecting the treatment workflow for the patient from a plurality of treatment workflows.
